(19) United States
(12) Patent Application Publication
(10) Pub. No.: US 2008/0022550 A1
(43) Pub. Date: Jan. 31, 2008

(54) Filtration System for Clothes Dryer

(76) Inventor: Ronald Anthony Masters, Loveland, OH (US)

Correspondence Address: LEMPIA BRAIDWOOD LLC, 223 W. JACKSON BLVD., SUITE 620, CHICAGO, IL, 60606, US

(21) Appl. No.: 11/831,460

(22) Filed: Jul. 31, 2007

Related U.S. Application Data
(60) Provisional application No. 60/834,427, filed on Jul. 31, 2006.

(51) Int. Cl. F26B 21/06; F26B 3/00

(52) U.S. Cl. 34/480; 34/82

(57) ABSTRACT

A filtration system is provided for a clothes dryer. The filtration system includes a filtration member that receives lint laden exhaust air that is expelled from the rotating drum of the dryer into an exhaust conduit during operation. The filtration system can be disposed in a portion of the exhaust conduit that is carried by the dryer housing, or can be disposed in a conduit that is external to the dryer housing. The filtration system can be used in combination with a conventional lint screen or independently, and is configured to remove lint from the lint laden exhaust air. The filtration material can be vacuumed as desired to remove lint that has been trapped in the material.

### CROSS-REFERENCE TO RELATED APPLICATIONS

This claims priority to U.S. Provisional Patent Application No. 60/834,427, filed Jul. 31, 2006, the disclosure of which is hereby incorporated by reference as if set forth in its entirety herein.

### STATEMENT REGARDING FEDERALLY SPONSORED RESEARCH OR DEVELOPMENT

None

### BACKGROUND

Conventional clothes dryers include a rotatable drum in which wet clothes are placed. During operation, the drum receives air that is heated from either electric or gas and circulated through the drum as the drum rotates. However, the drying and tumbling of the clothes frees a large quantity of lint from the clothes, which is carried by the air traveling through the drum. Accordingly, the dryer is equipped with a filter in the form of a mesh screen that receives the air exhausted from the drum. Unfortunately, while a significant amount of the lint is entrapped in the filter, the air nevertheless contains an amount of lint that renders the air unsuitable for direct emission into an interior room of a commercial or residential building, even after filtration. Also, the mesh screen requires cleaning after every cycle, and some lint is undesirably released to the air in the process of removing the lint from the screen by hand in the usual fashion.

As a result, dryer systems include one of two additional elements designed to alleviate the problem of venting lint laden air into the interior room. One proposed solution involves incorporating a port in the dryer that is disposed downstream of the filter. The port is connected to a conduit that extends to a vent disposed at the exterior of the interior room. Accordingly, the air is forced out into the outside atmosphere, thus sparing the building from receiving lint laden air. Unfortunately the conduit must, at times, span a distance that is greater than that recommended for fire safety reasons. Furthermore, such a system results in a significant amount of heat loss and is thus disadvantageous and inefficient, particularly in colder climates.

Another proposed solution designed to overcome the disadvantages associated with outside vents involves a secondary filter disposed downstream of the first mesh screen filter. Referring to FIG. 1, a conduit 22 receives air that has been filtered through the first filter (not shown) and extends from the dryer 20. The conduit 22 defines an outlet 24 that is disposed in a container 26 that includes a volume of water (or other liquid) 28 that defines a water level 30. Notably, the outlet 24 is disposed above the water level 30 such that it is not immersed in the water 28. During operation, the air is forced from the outlet, thus driving the lint into the water, where the lint is to be trapped. The twice-filtered air then exits the open end of the container 26 into the interior room.

Unfortunately, the system illustrated in FIG. 1 achieves only limited success and is subject to numerous disadvantages. For instance, the exposure of the exhaust air to water increases the moisture level of the exhaust air. As a result, the increased humidity in the interior room causes the air entering the dryer to have a higher humidity level, thus decreasing the efficiency of the drying cycle. Moreover, cleaning the container 26 is messy and inconvenient, as one can not simply pour the lint laden water down a conventional sink drain without the risk of substantial clogging. On the other hand, if the water is not removed and cleaned at frequent intervals, the standing water can become moldy, resulting in noxious odors and decreased sanitation levels in the interior room and in the air entering the drum. Additionally, if the water is allowed to evaporate, the filter will be rendered inoperable. Moreover, the surface area of the water 28 that receives lint from the exhaust air is relatively small and, as a result, has a limited ability to entrain all lint that is directed towards the water 28. Of course, the lint that is not entrained in the water exits into the interior room along with the air as it flows out of the container 26. Some systems attempt to mitigate this by using larger water tanks, thus creating a larger surface area of water that receives the lint. However, such systems create larger volumes of standing water, thus exacerbating the other disadvantages, such as mold and difficulties with clean-up, and fail to address the introduction of additional humidity into the airflow.

What is therefore needed is a filtration system for a clothes dryer that emits lint-free air into an interior space while avoiding the above-described disadvantages.

### SUMMARY

In one aspect of the invention, a filtration system is provided for a clothes dryer of the type having a dryer housing defining a drum, and a forced air source emitting air into the drum and emitting lint laden exhaust air through an exhaust conduit at a flow rate. The exhaust conduit has an input end and an output end to the ambient environment. The filtration system includes a filtration material supported in the exhaust conduit between the input end and the output end such that the exhaust air travels through the filtration material. The filtration material has a MERV less than 5 and has a thickness of at least ⅜-inch.

The foregoing and other aspects of the invention will appear from the following description. In the description, references are made to the accompanying drawings which form a part hereof, and in which there is shown by way of illustration, and not limitation, a preferred embodiment of the invention. Such embodiment does not necessarily represent the full scope of the invention, however, and reference must therefore be made to the claims for interpreting the scope of the invention.

### BRIEF DESCRIPTION OF THE DRAWINGS

Reference is hereby made to the following drawing in which like reference numerals correspond to like elements throughout, and in which:

FIG. 1 is a perspective view of a clothes dryer incorporating a a conventional liquid-based secondary filtration system;

FIG. 2 is a perspective view of a clothes dryer suitable for use in combination with the principles of the present invention;

FIG. 3 is a schematic sectional view of the interior of the clothes dryer illustrated in FIG. 2;

FIG. 4 is a perspective view of a clothes dryer connected to a filtration system constructed in accordance with certain aspects of the present invention;

FIG. 5 is a perspective view of a filtration system housing constructed in accordance with an alternative embodiment of the invention;

FIG. 6 is a perspective view of a filtration system housing constructed in accordance with another alternative embodiment of the invention;

FIG. 7 is a perspective view of a filtration system housing constructed in accordance with yet another alternative embodiment of the invention;

FIG. 8 is a perspective view of a clothes dryer having portions removed to illustrate a filtration system constructed in accordance with still another embodiment of the present invention;

FIG. 9 is a side elevation view similar to the filtration system illustrated in FIG. 8, but constructed in accordance with an alternative embodiment;

FIG. 10 is a perspective view of a filter member including a filtration material usable in combination with the filtration system constructed in accordance with certain aspects of the present invention;

FIG. 11A is a cross sectional view of the filtration material illustrated in FIG. 9;

FIG. 11B is a cross sectional view of a tightly packed filtration material; and

FIG. 12 is a schematic illustration of a test assembly used to perform a clothes dryer air flow test method.

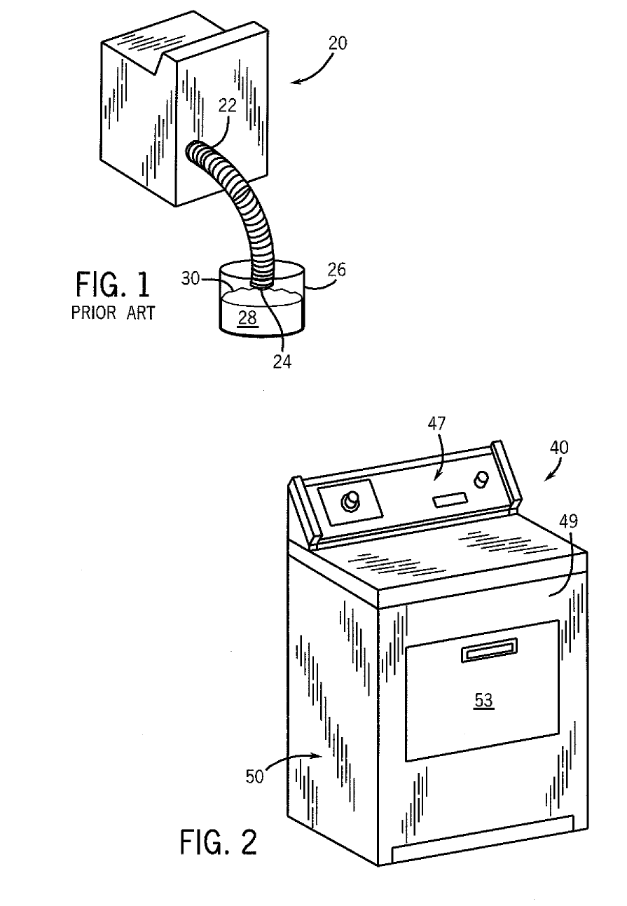

### DETAILED DESCRIPTION

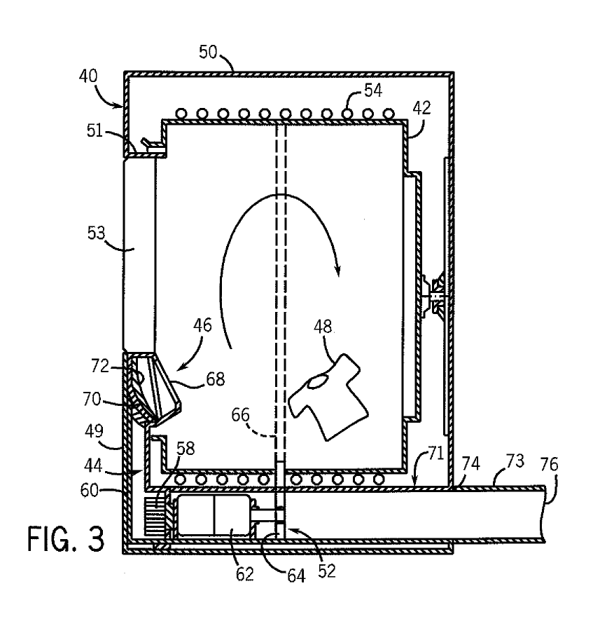

Referring now to FIGS. 2 and 3, a clothes dryer 40 constructed in accordance with one aspect of the present invention broadly includes a dryer housing 50 that defines a front wall 49 having an opening 51. The dryer housing 50 defines an internal laundry compartment or drum 42. A door 53 disposed at the opening 51 of the front wall 49 that can be opened to enable entry and removal of the clothing 48 into and out of the drum 42. When closed, the door 53 renders the drum 42 substantially airtight.

The drum 42 is a conventional dryer basket configured as a rotatable drum for receiving damp or wet laundry 48. The dryer housing 50 thus rotatably receives the drum 42 and supports a driving unit 52 that rotates the drum 42 so as to cause the laundry 48 disposed therein to tumble. Specifically, the driving unit 52 includes a double-shaft motor 62 that simultaneously turns the fan 58 and the drum 42. A pulley 64 on the motor 62, together with a belt 66 around the pulley 64 and the drum 42, transfer rotational forces to the drum 42. The dryer 40 can be operated by a user by way of various controls 47.

An opening (not shown) is disposed in the dryer housing 50 and provides an air intake for the heating cycle in the usual manner. At least one heating element 54 is disposed circumferentially about the outer surface of the rotatable drum 42. As illustrated, the heating element 54 is configured as an electric coil, however any suitable electric or gas heating element or elements could be used.

The dryer housing 50 carries an exhaust conduit 71 that links the drum 42 to the ambient environment. The exhaust conduit 71 includes an air passageway 44 defined by an exhaust casing 60 that is disposed in front of and below the drum 42 and carried by the dryer housing 50. An exhaust air interface 68 is disposed at the outlet of the drum 42 and the inlet of the exhaust casing 60 that allows the exhaust air to travel from the drum 42 to the exhaust conduit 71 via the air passageway 44. Specifically, an air mover, for instance a fan 58, is disposed inside the exhaust casing 60 that works in combination with the heater to circulate heated air generated the dryer 40 in and out of the drum 42. The fan 58 draws air into the dryer housing 50, past the heating element 54 (which heats the air), through the drum 42, and into through the exhaust conduit 71.

As illustrated, the exhaust casing 60 supports a lint screen assembly 46 operable to remove certain particulates from the air flowing through the air passageway 44. The lint screen assembly 46 includes a filter 70 which can be, for instance, in the form of a conventional lint screen or lint trap that is disposed in a lint screen compartment 72 located in the exhaust casing 60. As exhaust air exits the drum, the air travels through the filter 70, which collects, or traps, particulates such as lint that are freed from the clothes 48 during operation of the drying cycle.

In one aspect of the invention, the lint screen 70 is accessible to the user when the door 53 is open, such that the screen 70 can be easily removed, cleaned, and replaced as desired. Unfortunately, while conventional screens have proven successful in removing a percentage of the lint generated during the drying process, it is recognized that the air traveling through the screen 70 nevertheless contains a quantity of lint that renders the air unsuitable for expulsion into an interior room of a building.

The exhaust conduit 71 further includes an external outlet conduit 73 that extends through an outlet port 74 formed in the back of the dryer housing 50. The conduit 73 has a proximal end that is connected to the exhaust casing 60, thereby placing the air passageway 44 in fluid communication with the conduit 73. The conduit 73 has a distal end that defines an exhaust outlet 76. The outlet conduit 73 can therefore extend externally from the dryer 20 outside the dryer housing 50 and direct the exhaust air to a desired location, such as the ambient environment or a location located remote from the interior room in which the dryer 40 is disposed. Accordingly, air traveling through the screen 70 travels through the air passageway 44, and through the outlet conduit 73 prior to being expelled.

One skilled in the art will appreciate that while the present invention is described with reference to a clothes dryer of the type illustrated and described above with reference to FIGS. 2 and 3, the present invention is equally applicable to any clothes dryer that exhausts lint laden air that requires lint removal prior to being exhausted into an interior building space, or produces lint laden exhaust air unsuitable for being expelled into an interior building space.

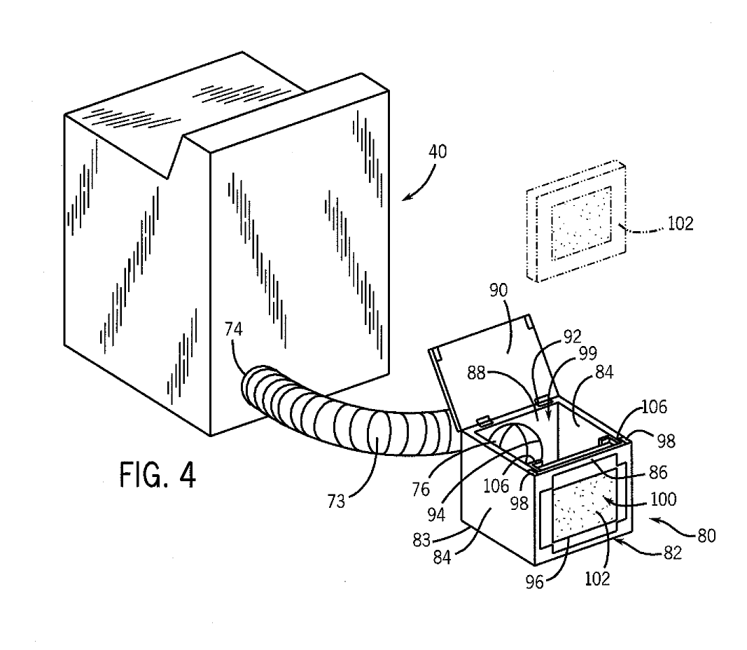

As illustrated in FIGS. 4-10, one aspect of the present invention includes a filtration system 80 that is configured to filter the air exhausted from the outlet port 74 of the clothes dryer and output filtered-air into an enclosed space, such as an interior room, for instance of a residence, in which the dryer 40 is disposed. The filtration system 80 can be used in combination with the conventional lint screen assembly 46, and disposed downstream of filter 70, and thus provide a secondary filtration system having secondary filtration components for the clothes dryer 40 that emits twice-filtered air. Alternatively, the filtration system can be used in place of filter 70 or upstream of an auxiliary filter, in which case the filtration system provides a primary filtration system having primary filtration components for the dryer 40 such that the exhaust air does not travel through another filter prior to traveling through the present filtration system. Further, the filtration system 80 can be disposed external to the dryer 40 and receive the exhaust air through a conduit, or the filtration system can be integrated into, or supported directly or indirectly by, the dryer housing 50. It should be appreciated that, unless otherwise stated, the terms “upstream” and “downstream” as used herein are used with reference to the direction of airflow.

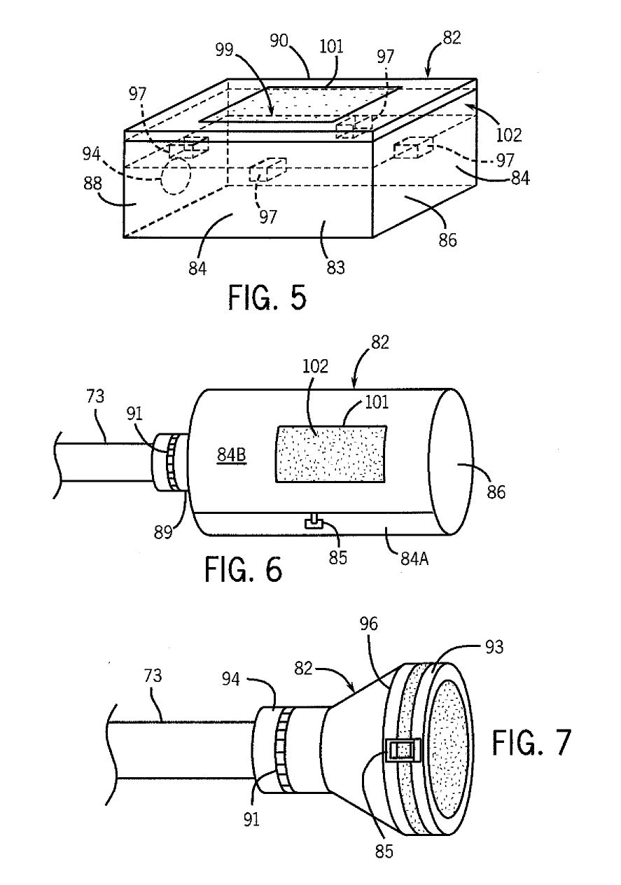

Referring now to FIGS. 4-5 in particular, a filtration system 80 will be described as being external to the dryer 40 and downstream from filter 70 with respect to the direction of airflow. The filtration system 80 is further disposed downstream of fan 58, and includes a filter member 100 that is in communication with the exhaust conduit 71 between the inlet and outlet ends 68 and 76, respectively. As illustrated, the filtration system 80 is connected to the outlet end 76 of the outlet conduit 73.

The filtration system 80 includes a housing 82 that defines a pair of opposing side walls 84, a rear end wall defined by the filter member 100 that is disposed downstream from a front end wall 88, a base 83, and a lid 90 that collectively define an interior void 99. The housing 82 can comprise any suitable material, such as wood, cardboard, plastic, metal, and the like. Preferably the material is lightweight, robust, and capable of efficient manufacture.

The lid 90 is attached to the upper end of the front end wall 88 via hinges 92 that facilitate opening and closing of the lid 90. The front end wall 88 defines an inlet opening 94 that receives the exhaust outlet 76 of the outlet conduit 73 in the manner illustrated and described with reference to FIG. 6. The incoming air and directs the once-filtered air into the interior void 99. The filter member 100 includes filtration material 102 and provides an exhaust outlet 96 that expels filtered air into a desired location, as will now be described. It should thus be appreciated that the filtration system 80 can be provided as a kit configured to retrofit an existing clothes dryer by connecting the outlet conduit 73 to the inlet opening 94 by for instance a collar 91 of the type illustrated in FIG. 6, a friction fitting, or any alternative suitable mechanical connection.

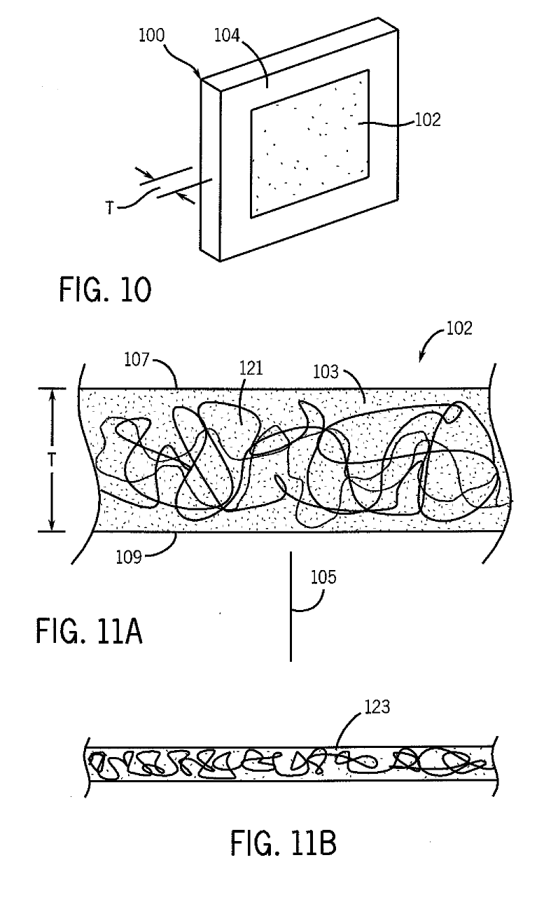

As shown in FIG. 10, the filter member 100 can include a frame 104 that structurally supports the filtration material 102. The material 102 can be attached to the frame in any known manner, for instance with a suitable adhesive such as tape or glue, mechanical fastener such as tacks and the like, or by any other known fastening system. The downstream ends of the side walls 84 each include vertically extending rails 106 that form an inwardly-oriented “U” groove that receives the frame 104 of the filter member 100. A user can thus easily slide the filter member in and out of the filtration system 80 for cleaning and replacement as desired.

During operation, the lid 90 is closed and locked onto a catch 98 carried by the upper end of the housing 82, thus providing a substantially air-tight void 99. The once-filtered, but still lint laden, air exits the dryer housing 50 through the outlet conduit 73 and flows into the void 99 and through the filtration material 102 of the filter member 100. As the air flows through the filtration material 102, the lint remaining after the initial filtration of the lint trap impinges on the material 102, thus producing clean air that exits the housing 82 via the outlet. The housing 82 thus exhausts twice-filtered air that is essentially lint-free and suitable for emission into an interior room of a building. Advantageously, the present invention enables heated exhaust air from a clothes dryer to be substantially free of lint, and emitted into the interior room in which the dryer is disposed. Moreover, the outlet conduit 73 can have a length that is substantially less than the maximum length currently recommended for fire and safety concerns. Furthermore, if the filtration system 80 is carried by the dryer housing 50, the outlet conduit 73 could be eliminated altogether.

It should be appreciated that the housing 82 illustrated and described above with reference to FIG. 4 could be constructed in accordance with any one of numerous alternative embodiments, each of which is contemplated by the present invention. For instance, referring to FIG. 5, the housing 82 is constructed as illustrated and described with reference to FIG. 4, however the rear end wall 86 is solid so as to prevent air from flowing therethrough. The filter member 100 is placed inside the void 99 through the open upped end of the housing 82 in a horizontal orientation.

The filter member 100 can be supported by any suitable ledge or shelf 97 extending inwardly from the side and/or end walls. Alternatively, the housing 82 could comprise a pair of shoebox-shaped members, one sized to fit inside the other, such that the free ends of the inner member would thus provide a ledge upon which the filter member 100 could be placed and supported in the interior void 99. The lid 90 is secured on top of the filter member 100, and defines an opening extending therethrough that provides an outlet 101 through which exhaust air can flow. The outlet 101 can be of any desired size and shape (limited, of course, by the dimensions of the housing 82 and/or filter member 100). Of course, the lid 90 can be hingedly attached via a latch that interlocks with a catch disposed on the side walls 84 and/or rear end wall 86 (not shown), or attached to the upper ends of the side and end walls in any suitable alternative manner.

As illustrated in FIG. 5, it should be appreciated that the filter member 100 need not include the frame 104, as the filter member does not include a catch that locks the lid 90 in place. Likewise, with respect to the housing 82 illustrated in FIG. 10, if lid 90 is configured to close in place without depending on the structure of the filter member 100, then the filter housing 82 would likewise be optional. The present invention recognizes that the structural integrity of the filtration material 102 is independently sufficient for insertion into the housing 82. If no frame 104 is provided, the filtration material 102 can be inserted into the housing 82 as described above. When the lid 90 is open, the filter member 100 or filtration material 102 can be easily removed from the housing 82, cleaned, and re-inserted into the housing 82. Alternatively, the filtration material 102 can be replaced as desired.

It should be appreciated that the housing 82 could comprise one of numerous alternative configurations. For instance, the filter member 100 or filtration material 102 could comprise either of the side walls 84, or could be disposed in the void 99 between the front end wall 88 and the rear end wall 86 such that all air entering the housing 82 is forced through the filter member 100 before exiting the housing 82 through an exit opening formed in any of the housing walls downstream of the filter member 100 or filtration material.

Another such alternative is illustrated in FIG. 6. Specifically, the filtration system 80 can include a housing 82 constructed in accordance with another alternative embodiment can be substantially cylindrical. Specifically, the housing 82 defines a cylindrical side wall 84, a front end wall 88 having an opening (not shown) that is connected to a cylindrical inlet 89 having an inner diameter only slightly greater than the outer diameter of the outlet conduit 73. Alternatively, the inner diameter of the outlet conduit 73 may be slightly greater than the cylindrical inlet 89 such that the inlet 89 is received by the conduit 73. The inlet 89 is connected to the conduit 73 in any known manner, for instance with a conventional collar 91. Of course, any alternative method for fastening the housing 82 to the conduit 73 that causes the exhaust air to flow through the filtration material 102 is intended to fall within the scope of the present invention. In one aspect, the inlet is formed from a metal to facilitate heat flow and minimize condensation of water vapor from the lint laden air. The rear end of the housing 82 is sealed with a rear end wall 86. The housing side wall 84 can comprise two joined side semi-cylindrical wall segments 84A and 84B that are hingedly connected and can be locked as desired by a conventional latch-catch mechanism 85.

An opening 101 in the side wall 84B provides an outlet port for the housing 82. The filtration material 102 can be attached to the inner surface of the wall 84B in any conventional manner such that it covers the outlet port 101, thus forcing exhaust air entering the housing 82 via the outlet conduit 73 to flow through the filtration material 102.

Alternatively, the side wall 84 can comprise a unitary structure, and the need for the latch-catch mechanism 85 can be avoided by covering the outlet port 101 with filtration material 102 disposed on the outside of the housing 82. For instance, a layer of the filtration material 102 can be wrapped around the side wall, thus covering the outlet port 101, and secured in any conventional manner, for instance via ties, clamps, Velcro, and the like. Alternatively, a patch of filtration material 102 can be placed on the outer surface of the side wall such that the material covers the outlet 101, and secured via conventional HVAC tape or the like.

Yet another such alternative is illustrated in FIG. 7. Specifically, the filtration system 80 constructed in accordance with another alternative embodiment includes a substantially frustoconically-shaped housing 82 whose smaller diameter defines a cylindrical inlet 94 and whose larger diameter defines a cylindrical outlet 96. In one aspect, the housing 82 can be formed from a metal to facilitate heat flow and minimize condensation of water vapor from the exhaust air.

The inlet 94 can be connected to the outlet conduit via a collar 91 in the manner described above with reference to FIG. 6. The filtration material 102 can be circular in shape, or any other suitable shape such that it is sized to fit over the outlet 96. A ring 93 having a diameter substantially equal to that of the outlet 96 can be positioned such that the filtration material 102 is captured between the ring 93 and the outlet 96. At least one clasp 85 or suitable alternative fasteners can connect the ring 93 and the outlet 96 to maintain the filtration material in position therebetween. Accordingly, during operation, lint laden exhaust air enters the inlet 94 via conduit 73, and flows through the housing 82 toward the filtration material 102 disposed at the outlet 96. The exhaust air flows through the filtration material 102, which captures the lint such that clean air is emitted from the outlet 96. When it is desired to clean or replace the filtration material, 102, the clasps 85 can be unlocked to remove the ring 93 from the housing 82. The filtration material 102 can then be cleaned and/or replaced as desired. Alternatively, the frustoconically-shaped housing inlet 94 may be pulled apart from the collar 91, revealing the interior of the filter unit and providing access to the filtration material 102 for cleaning purposes or replacement. In one embodiment of the invention the housing inlet 94 and collar 91 fit together by friction so that no additional clamps are required to secure the two units during operation.

While various alternative configurations have been illustrated for a filtration system 80 connected to the external outlet conduit 73, numerous other alternatives are contemplated in accordance with the principles of the present invention. The scope of the present invention is therefore not to be construed as being limited to the embodiments illustrated and described herein.

Furthermore, while the filtration system 80 has been described as a secondary filtration system disposed downstream of filter 70 and fan 58 with respect to exhaust airflow, it should be appreciated that filter 70 could be removed from the dryer, such that air flows from the drum 40, through passageway 44 and conduit 73, and into the filtration system 80 prior to passing through a filter, such as lint-removing filter 70. Furthermore, as will now be described, the filtration system 80 could be disposed upstream of the fan 58 with respect to the direction of airflow. Moreover, the filtration system 80 can be integrated into, or supported directly or indirectly by, the dryer housing 50.

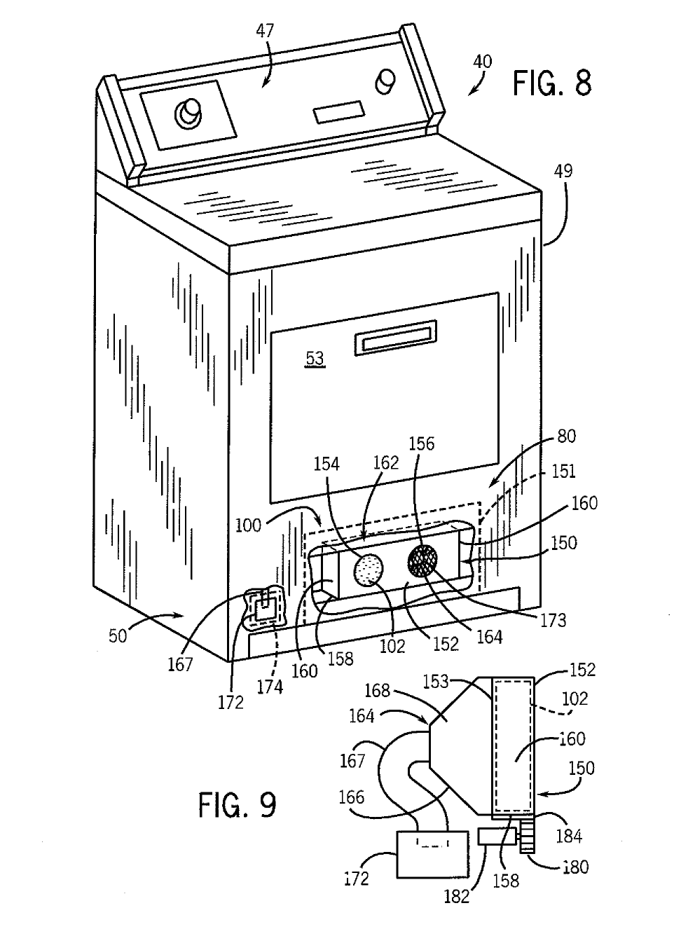

Specifically, referring now to FIG. 8, in another embodiment, the filtration system 80 replaces the lint screen 70 found in conventional clothes dryers. Specifically, the filtration member 100 includes a cartridge or compartment 150 disposed in the front wall of the dryer housing 50, and accessible via a door 151 formed in the housing 50 at a location below the door 53 that allows access to the drum 42 (the door is shown in phantom to illustrate the filtration system components).

The compartment 150 has an elongate rear surface 153 (see FIG. 9) facing the drum 42, and an opposing elongate front surface 152. The compartment 150 has a bottom surface 158, opposing side surfaces 160, and an open upper end 162. The filtration material 102 is disposed within the compartment and sandwiched between the front and rear surfaces, and extends laterally only approximately one-half the lateral dimension of the front and rear surfaces. A first aperture 154 extends through the front and rear surfaces, and is positioned in alignment to receive the lint laden exhaust air from the drum 42. The first aperture 154 therefore defines an “operating” position. A second aperture 156 extends through the inlet and outlet surfaces at a location adjacent the first aperture 154 and out of the exhaust air flow path, and defines a “cleaning” position. The filtration material 102 extends laterally across the compartment a distance greater than the diameter, or largest lateral dimension, of the apertures 154 and 156.

Referring also to FIG. 9, a vacuum 164 is supported by the dryer housing 50 and positioned in operable communication with the second aperture 156 at the rear surface. Specifically, the vacuum 164 includes a vacuum housing 166 having an intake end 168 that is in fluid communication with a conventional vacuum pump (not shown) disposed in the housing 166 configured to draw air into the intake end 168 at a high flow rate. The intake end 168 abuts the rear surface 153 of the compartment 150 such that the second aperture 156 is in alignment with the air flow path through the vacuum. A compliant material can be provided at the interface between the intake end 168 and the rear surface 153 to provide a reliable seal. Alternatively, the intake end 168 can be affixed to (either integrally or discretely) the rear wall 153. Alternatively still, the vacuum can be slidable with respect to the rear wall 153. A vacuum exhaust conduit 167 extends from the vacuum housing 166 and defines a distal end that terminates in an exhaust canister 172. The canister 172 can be accessed and removed from the dryer 20 as desired by opening a door 174 formed in the dryer housing 50 (the door 174 is shown in phantom to illustrate the canister 172 and conduit 167). Alternatively, the canister 172 can be positioned to be accessible via door 151. A screen 173 can be attached to the front surface and extend across the second opening 156 to protect the vacuum 164. The screen 173 can have a sufficiently open mesh so as to not restrict airflow into the vacuum 164 by an amount that would reduce the effectiveness of the cleaning operation.

During operation of the dryer 40, the filtration material 151 is aligned with the first aperture 154 such that the lint laden exhaust air emitted from the drum 42 passes through the filtration material 102 as it travels through the exhaust conduit 71. The filtration material 102 captures lint from the exhaust air, which exits the dryer 20 in the manner described above. When it is desired to clean the filtration material 102, the user can open the door 151, manually slide the filtration material 102 into alignment with the second aperture 156, and actuate the vacuum pump, which creates an airflow that applies a suction against the filtration material 102 and removes the lint that was captured during operation. The removed lint travels along the vacuum exhaust conduit 167 and is deposited in the canister 172.

The vacuum pump is deactivated after the filtration material 102 has been suitably cleaned (or if the filtration material 102 isn't easily visible for inspection, then after the expiration of a sufficient period of time. Advantageously, the present inventor has found that the filter can be sufficiently cleaned of lint in a short period of time, for instance between 5 and 30 seconds, depending on the configuration and power of the vacuum pump. When the canister 172 is full, the door 174 is opened, and the user can remove the exhaust conduit 167 (which can be formed from a rubber or like flexible material) from the canister 172. The canister 172 can then be removed from the dryer, and its contents emptied into a conventional receptacle. Once the canister 172 has been emptied, it is installed again in the dryer 20, the conduit 167 is inserted into the canister 172, the door 174 is closed, the filtration material 102 is moved into the operating position, and the door 151 is closed.

Alternatively, as illustrated in FIG. 9, the filtration material 102 can be automatically moved between the “operating” and “cleaning” positions, and the vacuum pump can be automatically actuated for a predetermined period of time once the filtration material has been moved to the “cleaning” position. Specifically, a rotatable pinion 180 is coupled to the drive end of a motor 182. A rack 184 is mounted to the lower surface of the filtration material 102 having teeth that engage teeth of the pinion 180. The controls can include a user interface, such as a switch, that controls the position of the filtration material, and drives the pinion 180 to rotate accordingly. Rotation of the pinion 180 drives the rack 184, and thus the filtration material 102, to translate between the “operating” and “cleaning” positions.

Advantageously, when the filtration system 82 is disposed within the dryer housing 50, or otherwise disposed upstream of the outlet port 74, a conventional conduit, such as outlet conduit 73 as illustrated in FIG. 3 that allows for the clean exhaust air to be vented to a location remote from the interior room housing the dryer 40, if desired, to remove moisture and/or heat from the room.

Because the filtration material 102 can be disposed at a position where it is subject to the airflow from the vacuum 164, the vacuum 164 is said to be operably coupled to the filtration material 102, or filter member 100. Advantageously, the operable coupling of the vacuum 164 to the filtration material 102 allows the filtration material to be easily and conveniently cleaned between usage.

While the vacuum 164 has been described as removing captured lint from the filtration material 102 when it is positioned as illustrated in FIGS. 8-9, it should be appreciated that a vacuum source can likewise be used to clean the filtration material 102 of with all of the embodiments described herein. Specifically, when the filtration material 102 becomes sufficiently clogged with lint, the vacuum inlet can be applied to the intake surface of the filtration material 102 to suck the lint out of and clean the material, thereby allowing the material to be replaced in the filtration system 80.

Referring now to FIGS. 10 and 11A in particular, it has been determined that the filtration material 102 suitable for use in the present invention should be sufficiently porous to enable an adequate flow of air therethrough during use, but at the same time sufficiently thick to achieve a suitable level of lint capture. In accordance with one aspect of the present invention, the filtration material 102 is formed from fibers or strands 103 that have a combined thickness T of at least ⅜-inch thick, and more preferably at least ½-inch, and still more preferably ¾-inch or thicker, has been found to be suitable.

In accordance with one aspect of the present invention, the filtration material 102 defines an upstream surface 107 and a downstream surface 109 relative to the flow of exhaust air. The filtration material 102 includes at least five layers of strands 103 offset between the upstream and downstream surfaces. One or more of the layers may be from a single fiber 103, or a combination of fibers 103 that make up the material 102. Accordingly, a plane 105 extending in a direction normal to the plane defined by the filtration material 102 and extending through the filtration material will encounter at least five of the fibers 103 offset between the upstream surface 107 and the downstream surface 109.

One example of a filtration material suitable for use is a material commercially available from HRS Textiles, Inc., located in Darlington, S.C., sold under the “HighLoft” product line. The filtration material fibers 103 can be formed from a synthetic (or thermoplastic) material (polyester in accordance with one aspect of the invention), and can have a high fiber-to-binder weight ratio to ensures that substantially more fiber is present in the filtration material 102 than binder. In accordance with certain aspects of the present invention, the weight of the filtration material 102 can range from approximately 0.5 to 1.5 ounces per square foot. This material is described in more detail in U.S. Pat. No. 6,120,633, the disclosure of which is hereby incorporated by reference as if set forth in its entirety herein.

The fibers of the filtration material 102 can further be provided with one or more of the following additives to enhance various properties of the filtration material 102. Specifically, the filtration material can include one or more of PDMS (polydimethylsiloxane) can as a slip/release agent to facilitate release of the captured lint fibers from the filter fibers, an alkylamide as a slip/antistatic agent, silica as a processing aid (fumed or fine silica to help adjust viscosity of thermoplastic when manufactured into the fibers), calcium carbonate as a filler (helps with smoke/flame control and controls cost), ATH (aluminum tri hydrate) as a fireproofing agent, DMMP (dimethyl methylphosphonate) as a fireproofing agent, TEP (triethylphosphate) as a plasticizer, Dioctyl Phthalate as a plasticizer, and DAP (diallyl phthalate) as flexibilizer/plasticizer.

Furthermore, the outer surfaces of the filtration material fibers can be coated with various property-enhancing coatings. Specifically, the filtration material 102 can be coated with one or more of fluoropolymers, such as PVDF (polyvinylidene fluoride) to provide a fireproofing/release agent, paraffin waxes (long chain alkane hydrocarbons) that provide a release and static generating agent, silocones, which provide a release and fireproofing agent, and also an antistatic agent, and PVC (Polyvinyl chloride), which provides a static generating agent. It should be appreciated that static generating agents will facilitate capture of the lint particles while Antistatic agents will facilitate release of the lint particles when the filter is cleaned. These agents can be used as desired to strike a suitable balance between these two properties. Advantageously, the material(s) that provide the coating and/or additive are insoluble in water.

In one aspect of the invention, the suitable filtration material 102 has been found to have a MERV (minimum efficiency recorded value as cited in ASHRAE 52.2-1999) less than 5, it being appreciated that standard HVAC filtration materials usable in combination with conventional furnaces have a MERV of about 8 or higher, with high efficiency models up to a MERV of 16.

It has been further determined that filtration material having a substantially open structure 121 (as opposed to a tightly packed structure 123 illustrated in FIG. 11B) is suitable. Specifically, it has been found that the open structure of the filtration material 82 achieves an airflow rate therethrough of at least 50% of the maximum airflow rate through the housing 82 (or through the conduit supporting the filtration material 82) when the filtration material 82 is not present. The airflow rate percentages are calculated using a clothes dryer measuring device and corresponding test method described in more detail below. Advantageously, it has been determined that the filtration material 102 retains between 50% and 100% flow even after multiple dryer load cycles. For instance, the present inventor has determined that the filtration material 102 retains at least 50% flow even after seven consecutive drying cycles without cleaning when positioned downstream of a primary lint screen, such as lint screen 70, that is cleaned every cycle, or 2 full cycles or more when used alone or as a primary filter disposed upstream of a secondary filter. In accordance with another aspect of the present invention, the maximum flow is at least 60% but less than 100%.

Clothes Dryer Air Flow Test Method

Purpose: To measure the actual clothes dryer air flow in use in determining the flow characteristics of secondary lint filters.

Materials:

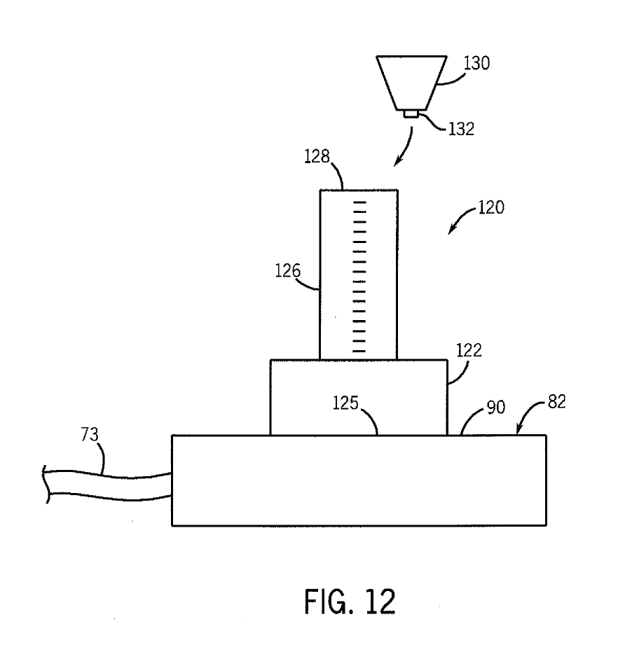

Referring to FIGS. 5 and 12, the filter housing 82 is provided as illustrated and described with reference to FIG. 5, but modified to provide a 4-inch outside diameter outlet port 101. The outlet port 101 is a standard 4-inch outside diameter PVC plumbing fitting, having a nominal inside diameter of at least 3.75 inches. Smaller inside diameters would provide artificial restriction of the dryer outlet air flow. It is preferable that the primary air flow restriction result from the filter material that is being tested.

An airflow test apparatus 120 is provided, including a generally rectangular base 122 having an open lower end 125 that is secured to the lid 90 using conventional HVAC tape such that all air exiting the housing 82 flows into the base 122. The HVAC tape facilitates the easy removal of the housing 82 from the base 122 so that the filtration material 102 can be replaced during testing. The upper end of the base 122 defines a 5-inch by 5-inch opening that is connected to a corresponding 5-inch by 5-inch square, vertically elongate, clear plastic chimney 126. The base 122 is secured to the chimney 126 by conventional plastic cement to effect a relatively permanent, and air-tight, attachment such that all air entering the base 122 from the housing 82 flows through the chimney 126. The chimney 126 is 11.5-inches tall, and marked in increments of ½-inch, with zero at the bottom and 11.5 at the top. The chimney 126 has an open upper end 128.

A 16-oz plastic drinking cup 130 is provided. During testing, the cup was 3.75 inches in diameter at the top, 2.5-inches in diameter at the bottom, 4.75-inches tall, and weighted with 2 U.S. standard 1-cent pennies 132 that are stacked and centrally secured to the bottom of the outside of the cup with 2 squares of aluminum duct tape. It should be appreciated, of course, that any suitable cup capable of consistently measured elevation in response to airflow through the chimney 126 during testing could be used, and that the cup can be weighted as necessary.

Various filter members having different material to be tested are provided, along with a digital camera (a Canon G3 was used for this test) and a computer to record the test flow results.

Test Procedure and Conditions

The clothes dryer is empty, as the presence of clothes reduces air flow.

The clothes dryer primary internal lint filter 70 is in place, dry, clean of lint, and cleaned with soap and water to remove any softener film, as restrictions at the primary filter will reduce air flow. The filtration system housing 82 is connected to conduit 73, the filtration material 102 is removed from the housing, and the lid 90 is closed. Next, the airflow test apparatus is sealed in place as illustrated and described above with reference to FIG. 12.

The clothes dryer 40 is turned on to the standard cycle and allowed to heat for 1 minute before the test cup 130 is inserted into the chimney 126 (unheated cycles produce more air flow). After the expiration of 1 minute, the cup 130 is inserted into the chimney and allowed to come to equilibrium for 10 seconds, at which point a photograph is taken to record the initial air flow, which is the maximum airflow rate through the housing 82.

The test is then repeated for the various filtration materials whose airflow is to be determined. The recorded air flow is then determined for each tested filter, and the corresponding measured values are divided by the initial air flow to determine the percentage of the maximum airflow rate through the housing 82.

The present inventor has found unexpectedly that the filtration material having the desired flow has a structure that is essentially the opposite from that normally sought for HVAC applications, which are typically thin with a tightly packed structure 123 (as opposed to the open structure 121 described above).

Advantageously, when lint laden air travels through the filtration material 102, the lint covers the fibers and thus assumes the shape of the fibrous material 102 as opposed to coating the upstream surface of the material as is the case with the lint screen 70. As a result, while the lint screen 70 requires cleaning after the completion of each drying cycle, the filtration material 102 is capable of providing adequate filtration (and at least 50% of the maximum airflow rate) after up to seven complete drying cycles.

The HRS Textiles, Inc. filtration material is conventionally used in furnaces for the removal of dust particles typically having a size between 3 and 10 microns (substantially smaller than the lint particles emitted by a clothes dryer). However, those having ordinary skill in the art recognize that such filtration material is conventionally cleaned by exposing the material to a stream of liquid, for instance water, to remove the particles that are entrained from the filtration material used in a furnace. When the material is entrained with lint, however, it has been determined that a pressurized stream of water is insufficient to clean the material. The present inventor found, however, that subjecting the lint laden surface of the material to a vacuum force is sufficient in removing the lint from the material.

Thus, the present invention has the further advantage of being easily and reliably cleaned. For instance, the user could insert a portable vacuum cleaner, or even an extension of a conventional upright vacuum cleaner, into the void and against the upstream surface of the filtration material to remove the entrained lint. Furthermore, the filtration material 102 is advantageously hydrophobic, and thus will therefore not become moldy during use, even though it is exposed to exhaust air having a high moisture content.

It should be appreciated that merely preferred embodiments of the invention and various aspects of the invention have been described above. However, many modifications and variations will be apparent to those skilled in the art, which will be within the spirit and scope of the invention. Therefore, the invention should not be limited to the described embodiments. To ascertain the full scope of the invention, the following claims should be referenced.

I claim:

1. In a clothes dryer of the type having a dryer housing defining a drum, and a forced air source emitting air into the drum and emitting lint laden exhaust air through an exhaust conduit at a flow rate, the exhaust conduit having an input end and an output end to the ambient environment, the improvement comprising:
a filtration system including a filtration material supported in the exhaust conduit between the input end and the output end, such that the exhaust air travels through the filtration material, wherein the filtration material has a MERV less than 5 and a thickness of at least ⅜-inch.

2. The improvement as recited in claim 1, wherein the thickness is at least ½-inch.

3. The improvement as recited in claim 1, wherein the filtration material comprises elongate strands of a synthetic material.

4. The improvement as recited in claim 3, wherein the filtration material comprises a thermoplastic.

5. The improvement as recited in claim 3, wherein the filtration material defines an upstream surface and a downstream surface relative to the exhaust air, the filtration material comprising at least five layers of strands offset between the upstream and downstream surfaces.

6. The improvement as recited in claim 5, wherein the offset strands are aligned such that a single plane extending normal to the filtration material and through the filtration material passes through the at least five layers of strands.

7. The improvement as recited in claim 1, wherein the filtration material has a weight ranging from 0.5 and 1.5 ounces per square foot.

8. The improvement as recited in claim 1, wherein the exhaust air travels through the filtration material at an airflow rate of at least 50% of a maximum airflow rate achieved through the conduit when the filtration material is removed.

9. The improvement as recited in claim 1, wherein the filtration system is disposed inside the dryer housing and receives the exhaust air from the drum, and wherein the filtration system is disposed in the exhaust casing.

10. The improvement as recited in claim 1, wherein the filtration system further comprises a vacuum and the filtration material is movable from a first position in the conduit to a second position aligned with the vacuum such that the vacuum can be activated to remove particles trapped in the filtration material.

11. The improvement as recited in claim 1, wherein the filtration system comprises a housing having an inlet that receives air from the exhaust conduit, and the housing retains the filtration material such that air traveling through the housing travels through the filtration material.

12. The improvement as recited in claim 1, wherein the exhaust conduit further comprises an external conduit extending outside the dryer housing, and the filtration system is connected to the external conduit.

13. The improvement as recited in claim 1, wherein a first filter is disposed at an outlet end of the drum at a location upstream of the filtration system with respect to the direction of air flow such that air flowing through the filtration system has been pre-filtered through the lint trap.

14. A clothes dryer comprising:
a dryer housing carrying a rotatable drum;
a heating element configured to heat air flowing into the drum;
an exhaust conduit connected between the drum and the ambient environment;
an air mover disposed in the exhaust conduit configured to move exhaust air from the drum through the exhaust conduit toward the ambient environment; and
a filtration system having at thickness of at least ⅜ inch and including a filtration material supported in the exhaust conduit between the input end and the output end, such that the exhaust air travels through the filtration material,
wherein the exhaust conduit has a maximum airflow rate when the filtration material is not present, and wherein the airflow rate through the filter is at least 50% of the maximum airflow rate.

15. The clothes dryer as recited in claim 14, wherein the filtration system is disposed downstream of a first filter with respect to air flow through the exhaust conduit.

16. The clothes dryer as recited in claim 14, wherein the exhaust conduit further comprises an external conduit extending outside the dryer housing, and the filtration system is connected to the external conduit.

17. The clothes dryer as recited in claim 14, wherein the filtration system is carried by the dryer housing and receives the exhaust air prior to the exhaust air traveling through another filter.

18. A filtration system kit configured to retrofit a clothes dryer of the type having a dryer housing defining a drum, and a forced air source emitting air into the drum and emitting lint laden exhaust air through an exhaust conduit at a flow rate, the exhaust conduit having an input end and an output end to the ambient environment, the filtration system kit comprising:
a housing attached having a housing inlet attached to the exhaust conduit and a housing outlet, wherein the housing supports a filtration material positioned such that air entering the housing inlet flows through the filtration material prior to exiting the housing outlet.

19. A method of operating a dryer of the type having a drum, a heating element operable to heat air moving into the drum, a conduit in communication with the drum, a filter attached to the conduit, and a vacuum operably coupled with the filter, the method comprising the steps of:
(A) forcing heated air into a drum so as to generate lint laden exhaust air;
(B) directing the exhaust air into the conduit and through the filter prior to being expelled;
(C) depositing lint from the air into the filter; and
(D) applying the vacuum to the filter to remove the deposited lint.

20. The method as recited in claim 19, wherein the filter comprises a filtration material having a MERV less than 5 and a thickness of at least ⅜-inch.

21. The method as recited in claim 20, wherein step (B) further comprises directing the exhaust air through the filter at an airflow rate of at least 50% of a maximum airflow rate when the filtration material is not present.
